(19) United States
(12) Patent Application Publication
(10) Pub. No.: US 2008/0091548 A1
(43) Pub. Date: Apr. 17, 2008

(54) Tag-Driven Concept-Centric Electronic Marketplace

(76) Inventors: Paul A. Kotas, Seattle, WA (US); Joseph C. Park, Seattle, WA (US)

Correspondence Address: LEE & HAYES, PLLC, 421 W. RIVERSIDE AVE, STE 500, SPOKANE, WA, 99201, US

(21) Appl. No.: 11/537,320

(22) Filed: Sep. 29, 2006

(51) Int. Cl. G06Q 30/00

(52) U.S. Cl. 705/26

(57) ABSTRACT

A domain that hosts a general e-commerce marketplace establishes multiple sub-domains to host niche electronic marketplaces. These niche sub-domain sites are built around a concept and offer for sale items that relevant to that concept. The items may be selected from the general e-commerce marketplace at the host domain, or from other websites. The selected items are assigned at least one tag that is associated with the concept, thereby associating the items with the niche electronic marketplace. Other tags may also be assigned to the items to facilitate item searching and comparison. The sub-domain sites may also offer in-depth item information and a rich shopping experience that is tailored to the sophisticated shoppers who are familiar with the concept. As such, the sub-domain sites might offer professional-level commentary, community-based discussion forums, wiki-like product descriptions, blogs, and so forth.

### BACKGROUND

Consumers are familiar with electronic marketplaces that offer for sale a wide range of products. Such marketplaces face unique problems when trying to connect consumers with seemingly countless products. Unlike traditional brick-and-mortar businesses, e-commerce sites do not have a physical store or location where a salesperson can help both novice and knowledgeable customers find sought after products. In the web environment, it is the customer's responsibility to identify a product that meets his or her needs. Even customers with considerable experience navigating e-commerce websites sometimes find it difficult to locate a desired product from among hundreds or thousands of offered products. For novice customers, the task of shopping online via the web can be unproductive and even frustrating.

E-commerce companies continue to look for ways to market a large selection of products to a wider audience. However, with an ever-enlarging product catalog and a growing customer base, it becomes increasingly difficult to satisfy the preferences of all customers who shop at the website. This is particularly true when trying to appease both the generalist shoppers and the hobbyist shoppers. Generalist shoppers are those who are simply trying to locate a type of product and any brand might do. These shoppers might be interested in learning a little about the various brands, and may even be willing to compare one or two products, but that is the extent of their involvement. In contrast, the hobbyist shoppers are those who are very familiar with the products and want to learn everything they can prior to making a purchase. They prefer to see specifications, compare features, and maybe even discuss the items with other hobbyists. Due to these differences, general e-commerce sites tend to appeal more to the generalist shoppers than to the hobbyist shoppers.

Accordingly, there continues to be a need for improving c-commerce experience across a wide and diverse customer base.

### SUMMARY

A domain that hosts a general e-commerce marketplace also establishes multiple sub-domains to host concept-centric electronic marketplaces. These niche sub-domain sites are built around a concept and offer for sale items relevant to that concept. The items may be selected from the general e-commerce marketplace at the host domain, or from other websites. The selected items are assigned semantic information that pertains to the concept, thereby associating the items with the niche electronic marketplace. For example, items offered at a sub-domain named “concept.domain.com” may be assigned a tag “concept” to associate the items with the sub-domain. Other tags may also be assigned to the items to facilitate or enhance item searching and comparison.

The sub-domain sites may also offer in-depth item information and a rich shopping experience that is tailored to the hobbyist or sophisticated shoppers who are knowledgeable about the concept. As such, the sub-domain sites might offer professional-level commentary, community-based discussion forums, wiki-like product descriptions, blogs, and so forth. The operators of the sub-domains and host domain may also enter into a business relationship that includes revenue sharing for items sold by the sub-domain sites.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an example architecture for implementing a tag-driven concept-centric electronic marketplace. The architecture includes multiple clients coupled via a network to one or more server systems that host a root domain with an electronic catalog as well as one or more sub-domains with concept-centric electronic catalogs.

FIG. 2 illustrates a screen rendering of an exemplary home page for an electronic marketplace found at the root domain.

FIG. 3 illustrates a screen rendering of an exemplary home page for a concept-centric electronic marketplace found at a sub-domain.

FIG. 4 is a block diagram illustrating selected modules in the server system that hosts the electronic marketplace found at the sub-domain.

FIG. 5 illustrates a screen rendering of a first exemplary page of an item tagging tool that facilitates searches for items to be included at the concept-based electronic marketplace.

FIG. 6 illustrates a screen rendering of a second exemplary page of an item tagging tool that facilitates identification and tagging of the items.

FIG. 7 is a flow diagram of a process for launching and operating a concept-centric electronic marketplace.

FIGS. 8 and 9 illustrate exemplary revenue sharing models for selling items through a concept-centric electronic marketplace found at the sub-domain.

### DETAILED DESCRIPTION

This disclosure is directed to electronic marketplaces accessible via a network, such as the Internet. Such marketplaces are often called c-commerce or merchant websites and, in the case of the Internet, are located at various domains across the World Wide Web. In particular, the following discussion pertains to electronic marketplaces that are developed around a concept or niche.

As an overview, each concept-centric electronic marketplace is launched as a sub-domain of a host domain, where the host domain may itself host a merchant website. As one example, suppose there are one or more sub-domains created from a root domain with a domain name of “domain.com”. The sub-domains might be given domain names such as “concept1.domain.com”, “concept2.domain.com”, and so on, where the “concept1” and “concept2” portions of the domain names pertain to various concepts around which the electronic marketplaces are designed.

The concept-centric electronic marketplaces may offer for sale items that are related to that concept or niche. Such items are identified and associated with the marketplace by assigning semantic information related to the concept. In one implementation, the items are assigned one or more semantic tags related to the concept. Tags are pieces of information separate from, but related to, the items. Each item is assigned at least one primary tag that associates the item with the sub-domain site. The primary tag is selected by the site operator who is establishing the concept-centric electronic marketplace. In one implementation, the tag applied to the items is identical to a portion of the sub-domain name. Continuing our example, items that appear on the electronic marketplace at “concept.domain.com” are thus assigned the tag “concept”. For instance, suppose the concept for one electronic marketplace is to sell jewelry and the concept for another electronic marketplace is to sell items that are black. The sub-domains for these marketplaces might be “jewelry.domain.com” and “black.domain.com”, with the corresponding primary tags being “jewelry” and “black”.

The items may further, or alternatively, be assigned one or more secondary tags that are not identical to the name portion of the sub-domain, but are nevertheless related to the concept. These secondary tags might include descriptors to characterize or otherwise describe attributes of the items. The secondary tags may be chosen by the operator when establishing the sub-domain site, or in a collaborative environment, by a community of many different users. For instance, for the jewelry-based electronic marketplace at “jewelry.domain.com”, the items made available at that site might be assigned tags such as “rings”, “necklaces”, and “diamonds”. With this additional flexibility, the site operator (or users of the site) can assign tags that are descriptive and might also specify properties of an item that may not otherwise be obvious from the item itself. Permitting different tags that are nonetheless associated with the concept enables the electronic marketplace to better support customer navigation, content searching, and item comparison.

In some cases, the concept-centric marketplaces may be multi-merchant marketplaces. Thus, each single item may also have one or more listings or offers to sell that item. Such offers may include charge-per-click offers.

Once established, the concept-centric electronic marketplace found at the sub-domain can support additional features to provide a rich user experience. The site may include commentary and analysis on the various items. Shoppers may be permitted to compare and contrast various items. The electronic marketplace may further provide a collaboratively-defined item encyclopedia, where users author descriptions of new items or edit existing item descriptions authored previously by themselves or others. As a result, the item descriptions become more accurate and uniform over time, thereby improving the user's ability to find items of interest on the electronic marketplace. Through this collaboration, users might be further empowered to define additional tags that characterize the items and identify attributes of the items. Over time, the collaboratively defined tags form a folksology (an attributed folksonomy) to categorize the items offered at the marketplace. Once assigned to items, the tags may be used to locate and organize the items, as well as facilitate comparison of various items.

In an alternative implementation, the concept-centric electronic marketplace may provide advertisements pertaining to the concept, rather than offering items for sale. The advertisements may be selected and placed on the marketplace by the sub-domain site operator. The rich content discussed above may also be included at the site, thereby providing a visitor with information about the concept as well as advertisements for products and services relating to the concept.

For purposes of discussion, the tag-driven concept-centric electronic marketplace is described in the following exemplary environment in which items are offered for sale. However, it should be appreciated that such marketplaces may be implemented in other environments, including ones in which advertisement serves as the revenue model rather than item sales.

Example System Architecture

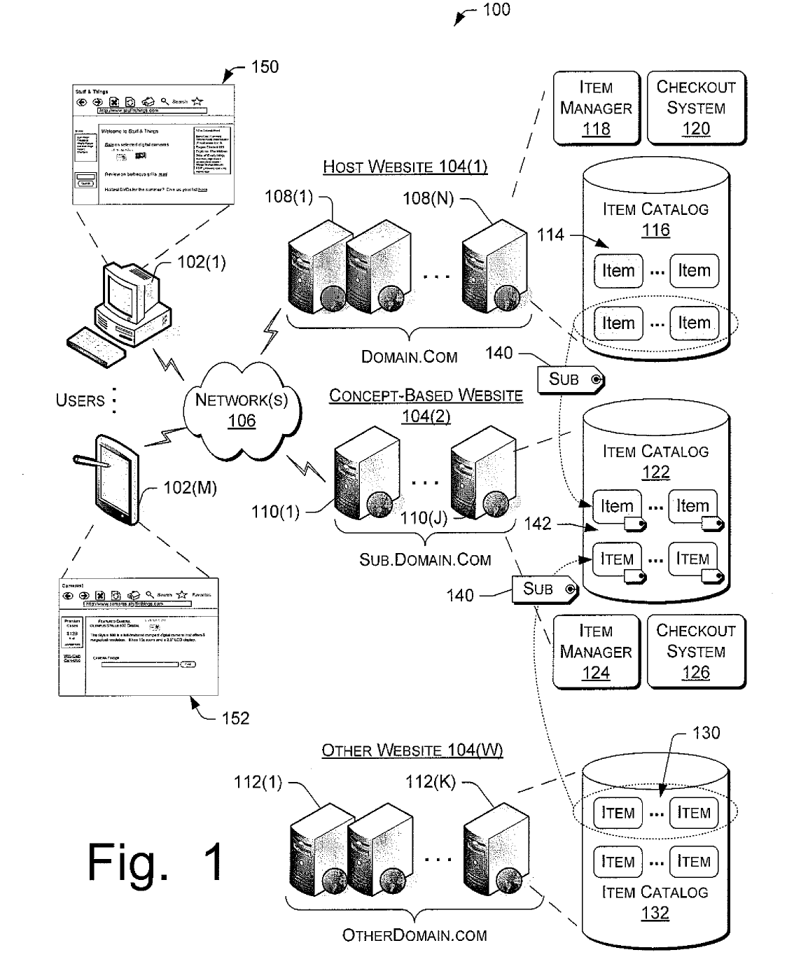

FIG. 1 illustrates an example architecture 100 in which a tag-driven concept-centric electronic marketplace may be implemented. In architecture 100, many user computing devices 102(1), . . . , 102(M) can access websites 104(1), 104(2), . . . , 104(W) via a network 106. The network 106 is representative of any one or combination of multiple different types of networks, such as cable networks, the Internet, and wireless networks.

Each website 104(1)-104(W) is hosted on one or more servers. In the illustrated arrangement, the website 104(1) is hosted on one or more servers 108(1), . . . , 108(N), the website 104(2) is hosted on one or more servers 110(1), . . . 110(J), and the website 104(W) is hosted on one or more servers 112(1), . . . , 112(K). In one implementation, the servers might be arranged in a cluster or as a server farm, although other server architectures may also be used to host the site. Each website is capable of handling requests from many users and serving, in response, various web pages that can be rendered at the user computing devices 102(1)-102(M). The websites 104(1)-104(W) can be essentially any type of website that offers items for sale, including online retailers, informational sites, search engine sites, news and entertainment sites, and so forth.

In the exemplary environment, the website 104(1) represents a merchant website that hosts an electronic catalog with one or more items. An item can be anything that the merchant wishes to offer for sale, or that others using the merchant's website wish to offer for sale. An item can include a product, a service, or some other type of sellable unit.

In FIG. 1, a collection of item records 114 are stored in an item catalog database 116, which is accessible, directly or indirectly, by one or more of the servers 108(1)-108(N). Each item record 114 contains information about an associated item being offered for sale on the merchant website 104(1). For products such as books or music CDs, for example, the item record may contain a description, images of the product, author/artist names, publication data, pricing, shipping information, and so forth. For other types of items, the item record may contain different information appropriate for those items.

An item manager 118 facilitates access to and management of the item records 114 in the catalog 116. The item manager 118 allows the website operator to add or remove items to the catalog 116, and generally maintain control of the items offered on the website 104(1). When a user requests information on an item from the website 104(1), one or more servers 108(1)-108(N) retrieve the item information from the item catalog 116 and serve one or more web pages containing the information to the requesting user computing device. The database 116 may therefore contain static web pages that are pre-generated and stored prior to such requests, or alternatively store data that is used to populate dynamic web pages that are generated in response to such requests.

The merchant website 104(1) also has a checkout system 120 that processes customers' purchases of items from the item catalog 116. The checkout system 120 facilitates user confirmation of items for purchase, collects payment and shipping information from the customers, provides electronic receipts to the customers, and then hands off delivery of the purchase to a fulfillment system (not shown).

Together, the servers 108(1)-108(N), item catalog database 116, item manager 118, and checkout system 120 form an electronic marketplace that resides at a specific domain on the Internet. For discussion purposes, suppose that the domain has a domain name identified by the URL (universal resource locator) “domain.com”.

A second website 104(2) represents another e-commerce website that hosts an electronic catalog with one or more items. The second website 104(2) is hosted on one or more servers 110(1)-110(J) and has its own item catalog database 122, item manager 124, and checkout system 126 that is separate from those of the host website 104(1). Together, the servers 110(1)-110(J), item catalog database 122, item manager 124 and checkout system 126 form another electronic marketplace that resides on the Internet. This marketplace is a concept-centric marketplace that is developed around a concept or theme. Hence, the second website 104(2) may be referred to as a concept-centric website. Items offered on the concept-centric website 104(2) relate to the concept. For instance, the concept might be jewelry, and the concept-centric marketplace is developed around the niche of selling jewelry online.

The concept-centric website 104(2) is formed as a sub-domain of the host domain website 104(1). In the Domain Name System (DNS) hierarchy, a sub-domain is a domain that is part of a larger domain. The DNS stores and associates many types of information with domain names, and translates domain names to IP addresses. In the illustrated example, the sub-domain has a domain name identified by “sub.domain.com”, which is a sub-domain of “domain.com” as exemplified by the naming structure of a prefix word “sub”, followed by a separating dot “.”, followed by the domain name “domain.com”. It is noted that the sub-domain website 104(2) may be physically hosted on the same set of servers used to host the first website 104(1) (i.e., the servers 108 and 110 are all part of the same server system) or hosted on separate servers that are still owned and operated by a common entity (i.e., such as the merchant that owns the merchant website 104(1)). Alternatively, the sub-domain website 104(2) may be physically hosted on servers 110 that are independent from servers 108, and separately owned and operated.

A third website 104(W) illustrated in FIG. 1 represents other possible merchant websites that host their own item catalogs with one or more items. A collection of item records 130 are stored in an item catalog database 132, which is accessible, directly or indirectly, by one or more of the servers 112(1)-112(K). The third website provides another electronic marketplace that resides on the Internet at a domain named, for example, “otherdomain.com”.

Returning again to the concept-centric website 104(2), it forms an electronic marketplace where item selection, merchandising, and marketing are provided by a different party than the owner/operator of the host website 104(1). Even though the concept-centric website 104(2) is a sub-domain of the host website, the third party owner and operator develops the theme, look and feel, and user experience independently of the host website. To launch the sub-domain site 104(2), the operator registers with the host domain to reserve a particular sub-domain. The sub-domain operator may also register the one or more tags used to identify items to be sold via the sub-domain's marketplace. The sub-domain operator may also provide information to support revenue sharing in the event that items provided by the host merchant website are sold on the concept-centric marketplace of the sub-domain. This registration might be done, for example, by visiting a registration location online at the host website 104(1).

The sub-domain operator may consist of a single person, a community of people, a single legal entity, or multiple entities. As one example, a group of part-time hobbyists might come together to form an electronic marketplace based on their hobby, and the work collectively together to manage, merchandise, and update the sub-domain site. The sub-domain may also be established as a non-profit legal entity so that revenue derived from selling items flows to the benefit of the non-profit organization or some other cause.

Once the concept-centric website 104(2) is built, the operator decides what types of items will appear on the site to fit within the concept. The items may be existing items already being offered on the host website 104(1) as well as items being offered on one or more other websites 104(W). In one implementation, the sub-domain operator identifies items that will appear on the concept-centric site 104(2) by searching other websites, including at “domain.com” hosted by the host website 104(1) and at other websites 104(W). Once items are identified, the sub-domain operator associates tags with those items. The tags relate to the concept. Any number of tags may be used and associated with the items selected.

In FIG. 1, the identification and tagging of items is pictorially represented by selection of certain item records 114 in the item catalog 116 hosted by website 104(1) and available at “domain.com”, and certain item records 130 in the item catalog 132 hosted by the other website 104(W). These selected item records are assigned tags 140 and stored as records 142 in the item catalog 122 associated with the concept-centric website 104(2). It is noted that the item catalog 122 may, in some implementations, be a logical subset of the item catalog 116, and hence run on the same platform.

As illustrated in FIG. 1, one tag assigned to the items has a name identical to the prefix portion of the sub-domain name. That is, suppose the sub-domain has a name structure of “sub.domain.com”, where the prefix “sub” portion defines, at least in part, the concept. One of the tags 140 is the word “sub” to identically match the prefix portion of the domain name. So, if the concept is jewelry, the sub-domain might be “jewelry.domain.com” and one of the tags 140 assigned to the items to be sold on the sub-domain is “jewelry”. Other tags 140 might include “rings”, “bracelets”, and “diamonds”. Similarly, if the concept is goods that are black, the sub-domain might be “black.domain.com” and one of the tags 140 assigned to items to be sold on “black.domain.com” is “black”.

Once the items are selected and tagged, the concept-centric sub-domain site is ready to launch. Users can then access the concept-centric electronic marketplaces at “sub.domain.com” independently of the marketplace hosted by the host website 104(1). Indeed, it is anticipated that the marketplaces would have a different look and feel so that the users may not even know that the two domains are affiliated in a domain and sub-domain relationship.

As shown in FIG. 1, user 102(1) may access the electronic marketplace at “domain.com” and be presented with one web page 150. Through that web page, the user can search for any number of items in the item catalog 116. Meanwhile, another user 102(M) might access the concept-centric electronic marketplace at “sub.domain.com” and be presented with another web page 152 that facilitates shopping of items in item catalog 122.

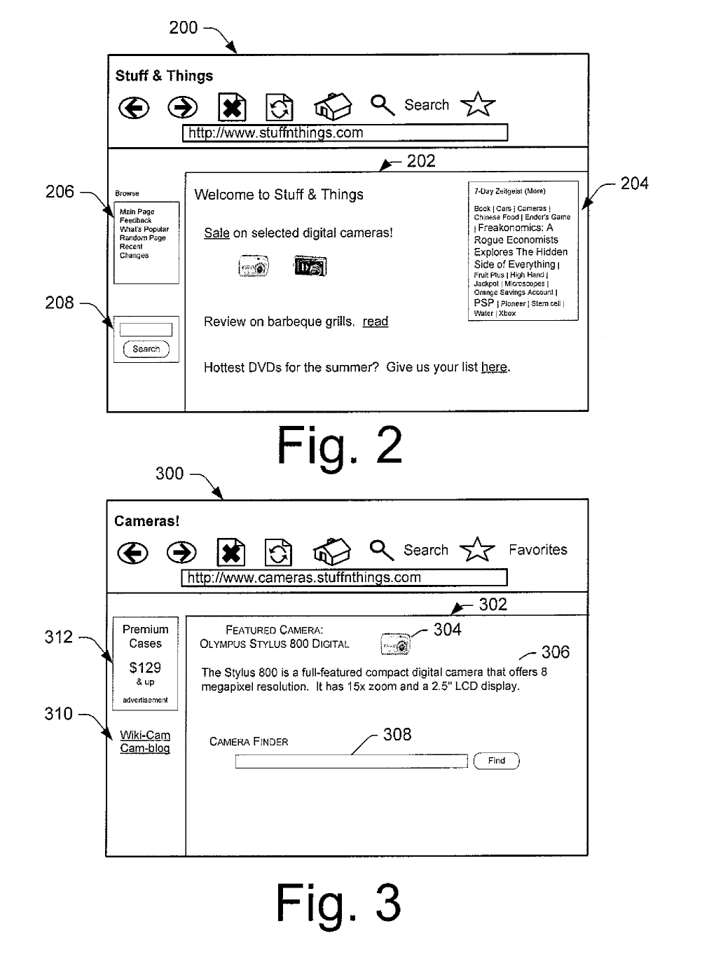

To better illustrate the user experience when visiting the two different marketplaces, FIGS. 2-3 show renderings of various web pages served by the domain website 104(1) and the sub-domain website 104(2). In this example, a general electronic marketplace is found at a fictional domain called “stuffnthings.com”. This general marketplace has a large item catalog that offers many different types of goods and services. A concept-centric electronic marketplace is found at a fictional sub-domain called “cameras.stuffnthings.com”, where the concept pertains to cameras.

FIG. 2 shows an example web page 200 that might be served and rendered, for example, when the user first accesses the general electronic marketplace at the domain named “stuffnthings.com” hosted by website 104(1). The web page 200 includes a welcome pane 202 with a greeting and a listing of special features currently available at the general electronic marketplace. In this example, the special features include a sale on selected digital cameras, a review of various barbeque grills, and an invitation for the user to provide his or her list of the 10 best summertime movies available on DVD. The web page 200 might also contain other controls or navigation tools, such as a zeitgeist 204 listing the most popular or interesting tags over the past seven day period, a list of navigation links 206, and a search tool 208.

The search tool 208 allows the user to locate items in the item catalog 116. By entering one or more key terms, users can search that catalog 116 in an effort to identify possible items matching those key terms. If one or more items exist, the website serves a web page with information about the item. The user may also access other web pages with product offerings by following the navigation links 206 or links provided in the zeitgeist 204.

FIG. 3 shows a rendering of web page 300 that might be served and rendered, for example, when a user first accesses the concept-centric niche marketplace at the sub-domain named “cameras.stuffnthings.com” hosted by website 104(2). Since this marketplace is developed around the concept of cameras, the content served in the web pages relate in some manner to cameras. Stated differently, this niche marketplace is all about cameras and the site operator focuses essentially exclusively on cameras and camera related items. The branding, color scheme, layout, and other look-and-feel components of the graphical user interface may be entirely different that that of the web pages 200 pertaining to the general marketplace, even though the concept-centric marketplace is a sub-domain of the domain for the general electronic marketplace. Moreover, the concept-centric marketplace might provide commentary, analysis, reviews, comparisons, and such about cameras. Through this differentiation, the user is given a different shopping experience when exploring cameras at this concept-centric marketplace in comparison to searching for cameras at the general marketplace.

In this illustration, the web page 300 includes a feature pane 302 that features one particular digital camera (i.e., “Olympus Stylus 800 Digital”). This feature pane 302 includes an image 304 of the camera and a brief description 306. The feature pane 302 further includes a search tool 308 that invites the user to search for other cameras available at the concept-centric marketplace or to locate information on cameras in general, regardless of whether they are offered for sale on the site.

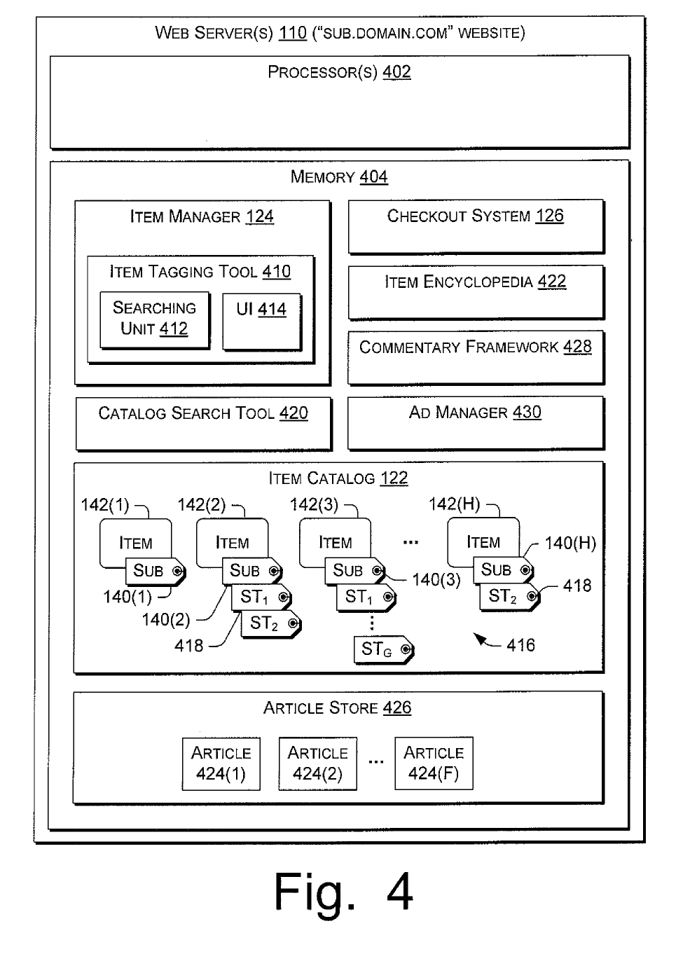

The search tool 308 allows users to search for items and features of those items by searching on tags that may be associated with the items. As noted above, all items are tagged with “camera”, but may also be assigned other tags that are descriptive of the item or specify features or properties of the items. These tags may be assigned by the manufacturer or supplier of the items, the sub-domain site operator, or users. The tagging is free-form in that anyone can add any tag. In some implementations, however, the site operator has final authority over the collection of tags and the items on the sub-domain (e.g., whether to allow users to add tags, or tag other items to add them to the electronic catalog, or otherwise manage existing tags). The tagging structure will be described below in more detail with reference to FIG. 4. In addition to search, the use of tags on items facilitates enhanced navigation and item comparison.

To provide an even richer user experience, the concept-centric electronic marketplace may further support other forums for sharing and discussing cameras. For instance, the sub-domain marketplace might include commentary and analysis of cameras provided by professional photographers. Or, perhaps well-known camera experts might maintain an electronic web-log (or “blog”) discussing the latest innovations in cameras. The sub-domain site might further support a community aspect where a community of hobbyists can comment via discussion boards or add content by creating and/or editing product description or authoring wiki-type articles. To support these rich experiences, the web page 300 may include links 310 to blogs (e.g., “cam-blog”) or to articles (e.g., “wiki-cam”). Here, the links are illustrated with underlining, although in practice the links may be represented using other techniques, such as color variation.

The sub-domain website 104(2) may provide rich authoritative information on the various items available at the concept-centric marketplace. This information may be created and controlled by the site operator and/or created by a community of users. Thus, the sub-domain website 104(2) may provide controls to assist users in creating new articles about items on the concept-centric electronic marketplace. These articles may include any information helpful to a user in learning about the item and deciding whether to purchase the item. Such information may include descriptions of the items, features and specification data, images of the item, intended uses, identities of manufacturers or distributors, accessories, and so on. These articles can be served by the servers 110 to the users to assist the users in better understanding the items.

In a collaborative implementation, the articles are community-authored, where any number of users may add, modify, or delete content contained in the article. Thus, individual users can author new articles and also edit existing articles crafted by other users. The edits can be logged and monitored to prevent malicious entries. Discussion pages, review history, and even the ability to watch pages may further be supported.

The web page 300 may further permit advertisements at the electronic marketplace. These advertisements might be, for example, targeted ads to camera users. In this example, an advertisement 312 offers a selection of camera cases.

With reference again to FIG. 1, the user computing devices 102 (also referred to as “client computers” or simply “clients”) may be implemented as any number of computing devices, including as a personal computer, a laptop computer, a portable digital assistant (PDA), a cell phone, a set-top box, a game console, and so forth. Each user computing device 102 is equipped with one or more processors and memory to store applications and data. A browser application provides access to the websites 104(1)-104(W). The browser renders web pages 150 and 152 served by the websites on an associated display, allowing the user to interact with the web pages.

When a user (e.g., user 102(M)) accesses the sub-domain site and purchases an item from the concept-centric marketplace, the checkout system 126 facilitates that purchase. The checkout system 126 facilitates user confirmation of items for purchase, collects payment and shipping information from the customers, provides receipts to the customers, and then hands off delivery of the purchase to a fulfillment system (not shown). It is noted that, in the illustrated implementation, the sub-domain site maintains its own checkout system 126 that is separate and independent from the checkout system 120 of the host domain. The fulfillment of the orders, however, may be facilitated by the fulfillment systems used by the merchant website 104(1) or other website 104(W).

Item Manager Implementation

FIG. 4 illustrates an example implementation of certain components used to implement the concept-centric electronic marketplace on one or more of the web servers 110(1)-110(J) that host the sub-domain website 104(2). The web server(s) 110 have processing capabilities and memory suitable to store and execute computer-executable instructions. In this example, the web server(s) 10 include one or more processors 402 and memory 404. The memory 404 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

The item manager 124 is implemented as software or computer-executable instructions stored in a memory 404 and executed by one or more processors 402. The item manager 124 is responsible for identification, selection, and management of the items 142(1), 142(2), . . . , 142(H) in the electronic catalog 122 exposed by the electronic marketplace. The item manager 124 includes an item tagging tool 410 to identify and tag items to be offered by the concept-centric electronic marketplace.

The item tagging tool 410 has a searching unit 412 and a user interface (UI) component 414. The searching unit 412 is employed to locate items that might be included in the sub-domain marketplace as relating to the concept. These items may reside at the merchant website 104(1) that hosts the general marketplace (i.e., at “domain.com”) and hence the searching unit 412 is used to search items 114 in the item catalog 116 (see FIG. 1). The items may also reside at other merchant websites 104(W) and the searching unit 412 conducts searches of items 130 in the item catalog 132. The UI 414 provides a graphical interface for initiating the searches and selecting items from the search results.

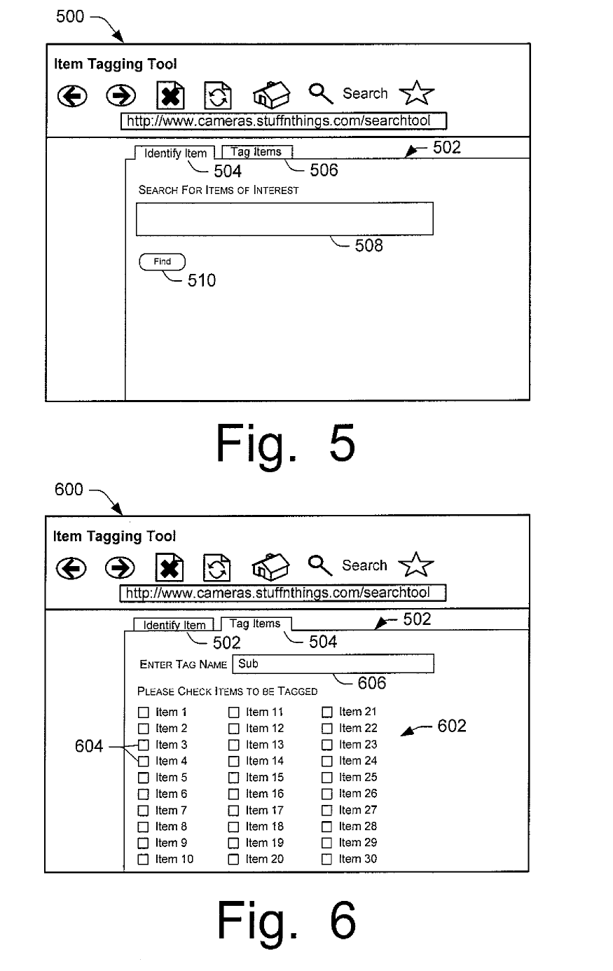

FIGS. 5 and 6 illustrate example screen renderings for the item tagging tool 410. FIG. 5 shows a first screen 500 provided by UI 414 for initiating searches to be conducted by the search unit 414. In this example, the screen 500 is a browser-rendered page with a control pane 502 that steps the sub-domain site operator through the identification and selection process. The control pane 502 has a first tab 504 to invoke a UI that aides in identifying items and a second tab 506 to invoke a UI that assists in tagging the items. In FIG. 5, the “identify item” tab 504 is selected and a search entry box 508 is presented for entry of search terms used to identify possible items to be included at the sub-domain marketplace. The search may be composed as a single term (e.g., “cameras”), as a string of terms (e.g., “digital cameras”), as a Boolean expression (e.g., “cameras” AND (“compact” OR “SLR”)), or as any other input. Once the search criteria are formulated, activation of a control button 510 initiates the search.

FIG. 6 shows a second screen 600 provided by UI 414 to present the results of the search. In this example, the “tag items” tab 506 of the control pane 502 is selected to show a list 602 of items that satisfied the search criteria. The list may be presented in many different formats, wherein the illustrated format is a simple listing of item names. Each item is accompanied by a selection box 604 (or some other control element) that permits the site operator to select those items to be included at the sub-domain marketplace, and other items to be excluded. By checking the appropriate boxes 604, the site operator designates those items to be included at the concept-centric marketplace.

Selected items may then be assigned one or more semantic tags. A tagging entry box 606 allows the operator to enter names of tags to be assigned to the items. In one implementation, all items to be included on the concept-centric electronic marketplace are assigned a common tag that associates the item with the marketplace. For instance, the sub-domain site operator might tag selected items with an initial tag that is identical to, or at least closely related to, the concept. This initial tag may be referred to as the “primary tag”. As shown on screen 600, a primary tag name “sub” is entered into the tagging entry box 606. This primary tag “sub” is identical to the prefix portion of the sub-domain's name “sub.domain.com”. It is further noted that in one implementation, such an identical primary tag may be assigned automatically to each item upon selection of that item from the search list 602.

After initially tagging all items with a primary tag, in certain implementations, the site operator and/or members of the user community (under the operator's control) may also use the item tagging tool 410 to add other tags to the items. These other tags, which are referred to as “secondary tags”. might pertain to properties or characteristics of the items to help facilitate navigation and item comparison.

The item tags are maintained in association with the items through a tagging data structure 416 kept in the item catalog. With reference again to FIG. 4, the primary tag “sub” (referenced by numbers 140(1), 140(2), . . . , 140(H)) is assigned to each item 142(1)-142(H). Continuing the above scenario where the concept pertains to cameras, the operator of the sub-domain “cameras.stuffnthings.com” might assign the primary tag “cameras” to the items by selecting items from the list 602 and entering the term “cameras” in the tag name entry box 606 of the item tagging tool (see FIG. 6).

As also shown in FIG. 4, multiple different secondary tags ST₁-ST_{G} (referenced generally as numbers 418) are assigned to various items, including items 140(2), 140(3) and 140(H). The same secondary tag may be applied to one or many different items (e.g., if the items share the same characteristic or property). For instance, suppose the site operator for the sub-domain “cameras.stuffnthings.com” wants to assign more descriptive tags that callout features or properties of the cameras. Example secondary tags might be “digital”, “Olympus”, “SLR”, “compact”, “underwater”, and so forth. The secondary tags enhance item search and comparison.

A catalog search tool 420 is another software tool that executes on the one or more servers 10 to assist the user in locating items 140(1)-140(H) in the catalog 122. The catalog search tool 420 supports key word searches entered by the user into the search UI 308 (FIG. 3) and searches the catalog 122 for any tags or item metadata matching or relevant to the key word. Once items with the same tags are located, they may be compared. For instance, a user may want to find and compare all compact digital cameras available on the sub-domain “cameras.stuffnthings.com”. The user would enter “compact” and “digital” as key words, and the catalog search tool 420 searches the catalog 122 for items with secondary tags 418 that match these key words.

Once the user locates an item and decides to make a purchase, the transaction is handled by the checkout system 126. The checkout system 126 leads the customer through a series of steps to ascertain the customer's name and address, preferred payment methodology, delivery information, and so forth.

The sub-domain site may further include an item encyclopedia 422, which facilitates creation and management articles 424(1), 424(2), . . . 424(F) describing the items 140 in the item catalog 122. The articles 424(1)-424(F) are stored in an article store 426.

The sub-domain site may further include a commentary framework 428 to facilitate user discussion and commentary of the products. The framework allows users to enter and post their commentary in any number of formats, including as a discussion board forum, a blog, or other formats. The framework further allows other users to offer feedback on the commentary.

An ad manager 430 is responsible for management of advertisements placed on the electronic marketplace, such as ad 312 in FIG. 2. The ad manager 430 decides what ads to display with what web pages, and may also include functionality to track how many times an ad is presented, whether the user clicked through the ad, and so forth.

Operation

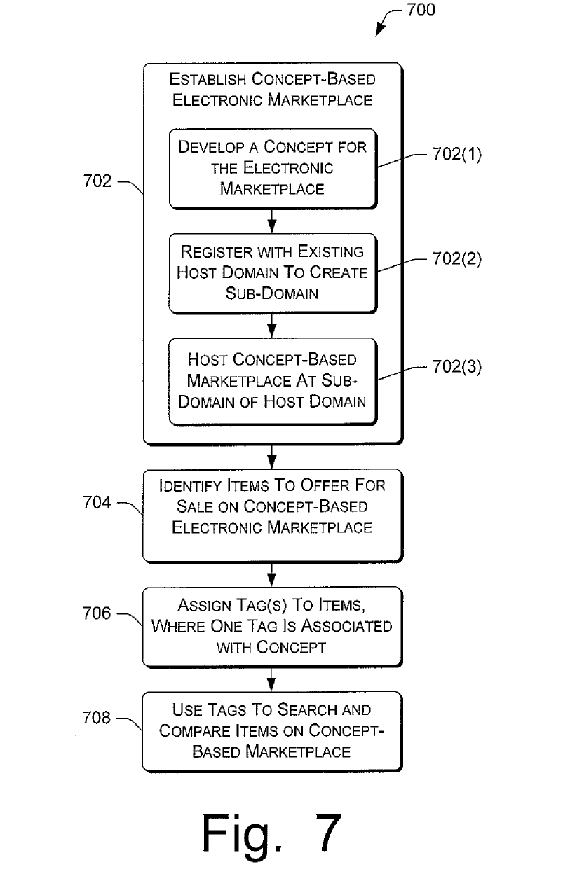

FIG. 7 illustrates an example process for launching and operating a concept-centric electronic marketplace as a sub-domain website. The process is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

For discussion purposes, the process is described with reference to the architecture 100 of FIG. 1, and the web server system of FIG. 4. In particular, many acts described below may be implemented and performed by the item manager and item tagging tool.

FIG. 7 shows a process 700 for launching a concept-centric electronic marketplace as a sub-domain website. At block 702, the concept-centric electronic marketplace is established. This operation may be viewed as a series of sub-operations 702(1)-702(3). At 702(1), a concept for the electronic marketplace is developed. The concept may result in any logical grouping of items, and may be based on item types (e.g., cameras, ties, barbeques, etc.), themes (e.g., travel, cooking, etc.), common properties (e.g., black items, small items, etc.), and the like.

At 702(2), a prospective owner of the concept-centric website registers with the host domain to create a sub-domain. The sub-domain is named according to the concept. Thus, if a prospective owner of a sub-domain site wants to launch a marketplace centered on the theme “travel”, the prospective owner might submit a registration to the operator of the host domain, say “domain.com”, to register the sub-domain “travel.domain.com”. If another prospective owner of a different sub-domain site wants to launch a marketplace centered on items with the property of being small, the prospective owner might register the sub-domain “tinyitems.domain.com”. It is noted that the host operator may allow any number of sub-domains to be established.

In some situations, the host domain operator may decide to award sub-domains on a first-come-first-served basis. Thus, the site operator who is first to register a particular concept is awarded a corresponding sub-domain. In other situations, however, the host domain operator may elect not to release the requested sub-domain name, but instead may ask the registrant to choose a more narrowly descriptive name and wait to award the broader sub-domain name to the operator that shows the most promise at best operating that sub-domain. For example, suppose there are a number of registrants for electronic marketplaces that pertain to the concept of cameras. Rather than registering the sub-domain “cameras.stuffnthings.com” (which is broadly descriptive of the type of goods) to the first registrant, the host domain operator may ask every registrant to choose a more descriptive, narrower name, such as “bobscamearas.stuffnthings.com” or “premiumcameras.stuffnthings.com”. Then, over time, the host domain operator can watch how the various operators perform and ultimately award the broader name “cameras.stuffnthings.com” to the sub-domain operator that performs the best. This performance may be based on any number of criteria such as community feedback, traffic flow to the sub-domain site, sales volume, and so forth.

At 702(3), the newly created sub-domain is hosted at the host domain. For example, the servers used to host the domain “stuffnthings.com” are also used to host the sub-domain “camera.stuffnthings.com”, as well as any number of other sub-domains. With reference to FIG. 1, the servers 108(1)-108(N) and 110(1)-110(J) are operated by the same entity, and are used to host both the host website 104(1) and concept-centric website 104(2). It is noted that in certain other implementations, the sub-domain may be hosted by servers independent from the servers for the host domain. Also, a separate entity may own the independent servers. However, in each situation, the operator of the sub-domain registers with the host domain.

After the concept-centric electronic marketplace is established, items to be offered for sale on the electronic marketplace are identified (block 704 in FIG. 4). The items relate in some manner to the concept around which the marketplace is developed. Thus, for a niche marketplace for cameras, the items may include cameras, lenses, film or memory sticks, and accessories. In one implementation, the items may be identified from the item catalog of the host domain. For example, with reference to FIG. 1, items 142 to be offered on the concept-centric website 104(2) may be identified by searching the item catalog 116 of the host website's marketplace. In one business arrangement, the host website may invite and encourage other operators to set up concept-centric marketplaces and thus make the tools available (such as the item tagging tool 410) to search and select items from its item catalog.

The items may be identified using the exemplary item tagging tool 410. As illustrated in FIGS. 5 and 6, the item tagging tool exposes a user interface that allows the sub-domain operator to enter key words to search for possible items. Example search words might be “camera”, “lens”, “photography”, “pictures”, and so forth. The search may be directed to one or more other item catalogs for websites with whom the operator has a business arrangement. The search results are then presented, as represented in FIG. 6, and the operator can select which items to include on the concept-centric electronic marketplace.

In other implementations, the items may be identified from one or more other websites. Again with reference to FIG. 1, items 142 to be offered on the concept-centric website 104(2) may be found by searching the item catalog 132 of another website 104(W). The same item tagging tool 410 may be used to search these databases as well.

Once items are identified, the items are assigned one or more tags (block 706 in FIG. 7). At least one tag is a primary tag that is identical to, or otherwise closely associated with the concept. For the concept-centric site “cameras.stuffnthings.com”, the primary tag might be “cameras” or “camera”. The primary tag is assigned by the site operator when initially launching the sub-domain site. The tag assignment may be accomplished using the item tagging tool, and particularly, via the UI 600 shown in FIG. 6. As shown in that figure, the sub-domain operator can elect certain items from the list 602 and assign a tag via tag entry field 606. The tag is then maintained in association with the item through a data structure in the item catalog 122, as shown in FIG. 4.

Other secondary tags may also be assigned to the items, either by the sub-domain operator or by users. Any number of secondary tags may be assigned to each item. These secondary tags are also associated with the items through the data structure. Using these secondary tags, users may search and compare items on the concept-centric electronic marketplace (block 708). For example, suppose a visitor to the sub-domain marketplace “cameras.stuffnthings.com” wants to find digital cameras and thus enter key words “digital” and “cameras”. The site search engine locates all items in the item catalog with a secondary tag “digital”. (Note that all items might be tagged with the primary tag “cameras”, so the search engine is configured filter results on the primary tag). From the search results, the visitor may compare the various items or filter them further to compare ones with additional characteristics, such as comparing digital cameras that are also “compact”. With the addition of this keyword, the list of items is further pared to those with a “compact” tag.

It is noted that discovery of items may be accomplished in ways other than through use of tags. For instance, in another approach, keyword searches may return a list of items and a user selects certain items of interest by highlighting the items, checking an associated box, or through other UI mechanisms.

Revenue Sharing

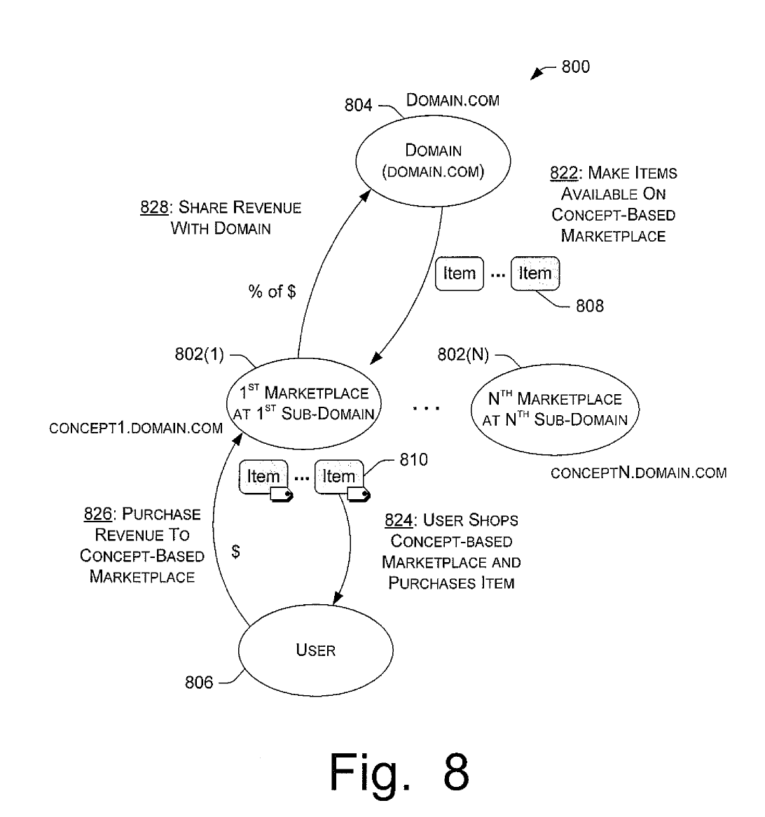

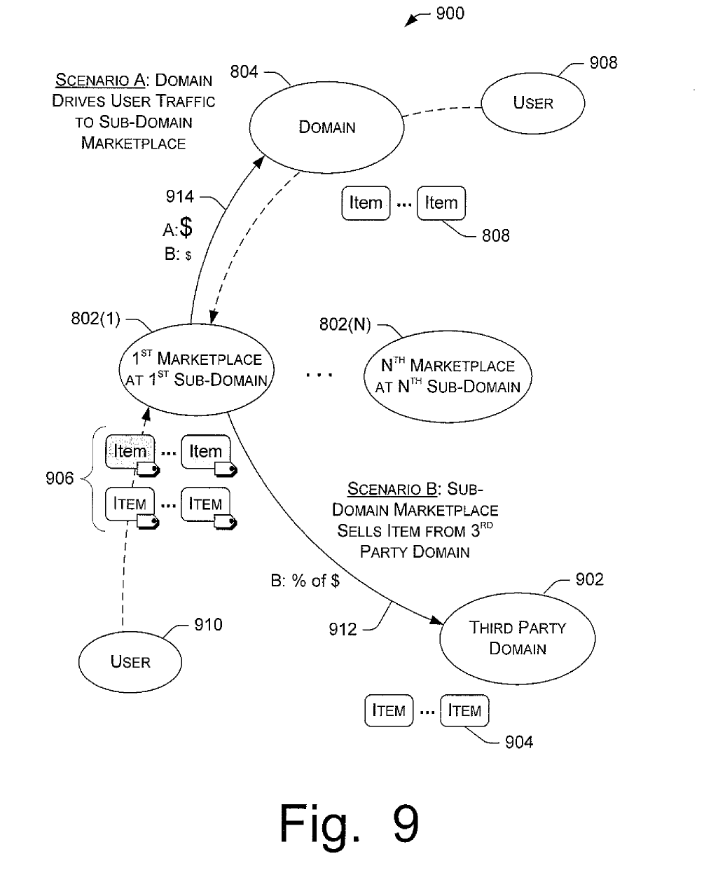

When registering and launching a concept-centric marketplace as a sub-domain website, the sub-domain operator enters into a business relationship with the domain operator. This relationship allows the sub-domain operator to use the sub-domain and to market items that are also included on the merchant website of the host domain. This relationship may or may not be exposed to the customers who visit the two sites. As part of this relationship, the domain and sub-domain operators may agree to a revenue sharing arrangement resulting from the sale of items on the concept-centric marketplace. FIGS. 8 and 9 illustrate different business models for sharing revenue among operators of the host domain, sub-domain, and possibly even third party domains.

FIG. 8 shows a first revenue sharing arrangement 800 in which multiple sub-domains 802(1), . . . , 802(N) have registered with a host domain 804 to operate concept-centric marketplaces. For this discussion, suppose that the host domain 804 also operates its own electronic marketplace that is accessible at a domain named “domain.com”. As illustrated, any number of proprietors may register with the domain 804 to operate concept-centric marketplaces.

For purposes of discussion, suppose the first sub-domain 802(1) operates a niche marketplace based around a first concept, and this marketplace may be found on the World Wide Web at “concept1.domain.com”. Similarly, the N^{th} sub-domain 802(N) operates a different niche marketplace based around another concept, and this N^{th} marketplace may be found on the World Wide Web at “conceptN.domain.com”, A user 806 may visit any one of the online electronic marketplaces at the host domain 804 or one of the sub-domains 802(1)-802(N). The user 806 may go directly to the particular electronic marketplace by entering the domain name into a browser, or be referred to one of the sub-domains 802(1)-802(N) via a link exposed at the host domain 804.

The concepts for each sub-domain may be distinct form one another (e.g., jewelry, tools, ties, telescopes, DVD movies, etc.), or groups of sub-domains might share a common concept. As an example of this latter situation, suppose multiple proprietors are interested in registering sub-domains developed to market cameras. Rather than limiting registration to one sub-domain for cameras, the host domain may choose to register multiple sub-domains for cameras, with each sub-domain having its own unique domain name (e.g., “premiumcameras.domain.com”, “bobscamearas.domain.com”, etc.).

One particular business arrangement between the host domain 804 and the first sub-domain 802(1) will now be described with reference to FIG. 8. In this arrangement, the sub-domain 802(1) shares revenues with the host domain 804 in exchange for being permitted to operate the sub-domain and for having access to sell items available at the host domain.

At 822, the first sub-domain 802(1) establishes its electronic marketplace by selecting from items 808 that are marketed and sold by the host domain 804. The identified items are tagged with a primary tag to associate them with the first electronic marketplace at the first sub-domain 802(1), as represented by tagged items 810. At 824, the user 806 visits the marketplace at the first sub-domain 802(1) and purchases one of the items. At 826, purchase revenue is passed from the user 806 to the sub-domain 802(1). At 828, a percentage of that revenue is shared with the host domain 804. In this arrangement, the host domain receives less revenue than had it sold the item directly to the user, but is expecting to increase overall revenues as a result of fostering many niche marketplaces that sell incrementally more items.

It is further noted that the operator of the sub-domain may be a group of individuals. In this case, the individuals may further elect to share the portion of the revenue allocated to the sub-domain. This secondary revenue sharing may be decided in a number of ways, including by contribution level, contract, or other techniques.

FIG. 9 shows a revenue sharing model 900 to describe two other possible revenue sharing arrangements among the operators of the sub-domain and host domain, as well as with another domain run by a third party. As illustrated, multiple sub-domains 802(1), . . . , 802(N) have registered with the host domain 804 to operate concept-centric marketplaces. The host domain 804 operates an electronic marketplace that sells items 808 and a third party domain 902 operates a different electronic marketplace that sells other items 904.

The first sub-domain 802(1) hosts an electronic marketplace that sells items selected in part from items 808 of the host domain 804 and in part from items 904 of the third party domain 902. The items selected from the different domains are tagged with a common primary tag to associates the items with the electronic marketplace at the first sub-domain 802(1), as represented by tagged items 906.

In a first scenario A, a user 908 visits the host domain 804. During that visit, the host domain 804 refers the user to the sub-domain 802(1), as pictorially represented by the dashed line from the user 908 through the domain 804 to the sub-domain 802(1). The user then purchases an item 906 from the first electronic marketplace at the sub-domain 802(1). Part of the revenue from this purchase is shared by the sub-domain operator with an operator of the host domain 804 for referral of the customer. Additionally, the amount of revenue shared with the host domain 804 for this referral may vary depending upon whether the customer 908 purchased an item 906 that could also be found on the host domain 804 (i.e., item 808) or on the third party domain 902 (i.e., item 904), where more revenue is shared in the former case and less revenue is shared in the latter case. Moreover, the revenue sharing arrangement for customer referral may be entirely separate and distinct from any sharing arrangement pertaining to the sale of items that are also found on the host domain 804, as described above with respect to FIG. 8.

In a second scenario B, another user 910 visits the sub-domain 802(1) without being referred by the host domain 804. Upon purchase of an item 906 that was originally selected from the third party domain 902 for sale on the concept-centric marketplace of the sub-domain 802(1), a portion of the revenue is shared with operators of the third party domain 902, as represented by monetary flow arrow 912. Additionally, a small portion of the revenue may be shared with the host domain 804 for providing permission to operate the sub-domain. In this scenario, however, the amount of revenue that the host domain 804 receives is smaller than the revenue received in scenario A described above, as represented by the different sized “$” signs for scenarios A and B in the monetary flow arrow 914 from sub-domain 802(1) to domain 804.

Thus, there are many revenue sharing components that may be considered when establishing a relationship between the host domain 804 and each of the sub-domains 802(1)-802(N). These components include, but are not limited to, a component for being permitted to operate a sub-domain to the domain, a component for selling an item that is also marketed and sold by the host domain, and a component for receiving a referral from the host domain.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
establishing an electronic marketplace associated with a concept, wherein the electronic marketplace is located at a sub-domain of a domain website and at least part of a domain name of the sub-domain is related to the concept;
identifying items to be offered at the electronic marketplace; and
associating, with the items, semantic information pertaining to the concept.

2. A method as recited in claim 1, wherein the electronic marketplace is established by a multiple entities.

3. A method as recited in claim 1, wherein the electronic marketplace is established by a first entity that is separate and distinct from a second entity that operates the domain website.

4. A method as recited in claim 1, wherein the domain name of the sub-domain is structured as “sub.domain.com”, and a prefix portion “sub” of the domain name includes, at least in part, a word related to the concept.

5. A method as recited in claim 1, wherein the domain name of the sub-domain is structured as “sub.domain.com”, where a prefix portion “sub” of a domain name refers to the concept, and the associating comprises assigning a tag with a name that is identical to the prefix portion.

6. A method as recited in claim 1, wherein the identifying comprises searching for items available on one or more other electronic marketplaces and enabling selection of certain items for inclusion at the electronic marketplace.

7. A method as recited in claim 6, wherein the searching and selection are performed using a graphical user interface.

8. A method as recited in claim 1, wherein the associating comprises tagging the items with tags associated with the concept.

9. A method as recited in claim 8, wherein the tagging comprises assigning a primary tag to each of the items, and assigning one or more secondary tags to one or more of the items.

10. A method as recited in claim 1, further comprising sharing revenue resulting from items sold at the electronic marketplace among a first entity that operates the domain website and a second entity that operates the electronic marketplace at the sub-domain.

11. A method as recited in claim 1, further comprising sharing revenue resulting from items sold at the electronic marketplace among a first entity that operates the domain website and a second entity that operates the electronic marketplace at the sub-domain, wherein the revenue sharing differs depending upon whether purchasers of the items were referred to the electronic marketplace from the domain or from another source.

12. A method as recited in claim 1, further comprising facilitating collaborative development of item descriptions by a community of multiple users.

13. A method as recited in claim 1, further comprising selling advertisement space on the electronic marketplace to one or more third parties.

14. A method as recited in claim 1, wherein the electronic marketplace located at the sub-domain is a first electronic marketplace and a second electronic marketplace is located at the domain website, the method further comprising:
facilitating item selection and purchase using a first checkout system for items on the first electronic marketplace at the sub-domain; and
facilitating item selection and purchase using a second checkout system for items on the second electronic marketplace at the domain website, wherein the second checkout system is independent of the first checkout system.

15. One or more computing devices, comprising:
one or more processors; and
memory to store computer-executable instructions that, when executed by the one or more processors, perform the method of claim 1.

16. A method comprising:
registering with a host domain to operate a sub-domain;
developing an electronic marketplace for the sub-domain, the electronic marketplace being developed around a concept; and
tagging items to be sold at the electronic marketplace with at least one tag related to the concept.

17. A method as recited in claim 16, wherein the host domain offers items to customers, and the tagging comprises assigning the tag to selected items offered by the host domain to mark the selected items for offering on the electronic marketplace of the sub-domain.

18. A method as recited in claim 16, wherein all items to be sold at the electronic marketplace are tagged with a common tag.

19. A method as recited in claim 16, wherein the sub-domain has a domain name structured as “sub.domain.com”, where a prefix portion “sub” of the domain name refers to the concept, and the tagging comprises assigning a tag with a name that is identical to the prefix portion.

20. A method comprising:
hosting a first electronic marketplace at a domain;
hosting at least one second electronic marketplace at a corresponding sub-domain to the domain, wherein the second electronic marketplace is developed around a concept;
identifying items offered on at least one of the first electronic marketplace and other electronic marketplaces; and
assigning one or more tags to the identified items, wherein at least one tag is associated with the concept for the second electronic marketplace.

21. A method as recited in claim 20, wherein the sub-domain has a domain name structured as “sub.domain.com”, where a prefix portion “sub” of the domain name refers to the concept, and the at least one tag assigned to the items is identical to the prefix portion

22. A method as recited in claim 20, wherein the assigning further comprises assigning a primary tag associated with the concept and one or more secondary tags to the one or more items.

23. A method as recited in claim 20, further comprising facilitating search of the items on the second marketplace using the tags.

24. A method as recited in claim 20, further comprising sharing revenue resulting from items sold at the second electronic marketplace among a first entity that operates the domain and a second entity that operates the second electronic marketplace.

25. A method as recited in claim 20, further comprising facilitating collaborative development of item descriptions on the second electronic marketplace by a community of multiple users.

26. A method as recited in claim 20, further comprising selling advertisement space on the second electronic marketplace to one or more third parties.

27. A method, comprising:
establishing an electronic marketplace associated with a concept, wherein the electronic marketplace is located at a sub-domain of a domain website and at least part of a domain name of the sub-domain is related to the concept;
identifying items to be offered at the electronic marketplace; and
sharing revenue resulting from a sale of the items offered at the electronic marketplace among a first entity that operates the domain website and a second entity that operates the electronic marketplace at the sub-domain.

28. A method as recited in claim 27, wherein the revenue shared differs depending upon whether purchasers of the items were referred to the electronic marketplace from the domain or from another source.

29. A method as recited in claim 27, wherein the second entity comprises multiple individuals and further comprising distributing portions of the revenue share attributed to the second entity among the individuals.

30. A method as recited in claim 27, wherein the domain name of the sub-domain is structured as “sub.domain.com”, and a prefix portion “sub” of the domain name includes, at least in part, a word related to the concept.

31. A method as recited in claim 27, further comprising associating, with the items, semantic information pertaining to the concept.

32. A method as recited in claim 27, further comprising tagging the items with tags associated with the concept.

33. One or more computing devices, comprising:
one or more processors; and
memory to store computer-executable instructions that, when executed by the one or more processors, perform the method of claim 27.

34. A tagging data structure embodied on a computer-readable media, the data structure comprising:
a primary tag to associate an item with a particular electronic marketplace; and
one or more secondary tags to provide attributes of the item.

35. A tagging data structure as recited in claim 34, wherein the primary tag is identical for all items.

36. A tagging data structure as recited in claim 34, wherein the electronic marketplace is hosted at a sub-domain having a domain name structured as “sub.domain.com” and the primary tag is identical to a prefix portion “sub” of the domain name.

37. A server system for hosting an electronic catalog, comprising:
one or more computing devices to receive requests for information about items in an electronic catalog; and
the tagging data structure as recited in claim 34, stored and executed by the one or more computing devices, to enable users to search for the items in the electronic catalog using the secondary tags.

38. A server system comprising:
one or more processors;
a memory, accessible by the one or more processors;
an item manager stored in the memory and executable on the one or more processors to manage items in an electronic catalog, the item manager facilitating identification and tagging of items available in one or more other electronic catalogs for inclusion in the electronic catalog; and
a tagging data structure comprising a primary tag to associate an item with the electronic catalog and one or more secondary tags to provide attributes of the item.

39. A server system as recited in claim 38, wherein the electronic catalog is exposed via a concept-centric electronic marketplace established at a sub-domain website, the sub-domain website having a domain name that refers to a concept and the primary tag relates to the concept.

40. A server system as recited in claim 38, wherein the item manager comprises an item tagging tool that allows tagging of the items with the primary and secondary tags.

41. A server system as recited in claim 38, further comprising a checkout system to facilitate item selection and purchase of items from the electronic catalog.

42. A server system as recited in claim 38, further comprising an item encyclopedia to enable a community of users to collaborate on descriptions of items in the electronic catalog.

43. One or more computer-readable media comprising computer-executable instructions that, when executed on one or more processors, perform acts comprising:
searching for items available on one or more electronic catalogs associated with one or more electronic marketplaces;
selecting certain items resulting from the searching for inclusion in a particular electronic catalog associated with a concept-centric electronic marketplace, the items being relevant to a concept around which the concept-centric electronic marketplace is developed;
assigning a primary tag to the certain items, wherein the primary tag associates the certain items with the concept-centric electronic marketplace; and
assigning secondary tags to one or more of the certain items.

44. One or more computer-readable media as recited in claim 43, further comprising computer-executable instructions that, when executed on one or more processors, perform an additional act comprising using the secondary tags to facilitate search of the items on the particular electronic catalog.

45. One or more computer-readable media as recited in claim 43, wherein the concept-centric electronic marketplace resides at a sub-domain with a domain name that includes a word relevant to the concept, and the primary tag is identical to the word.
